(19) United States
(12) Patent Application Publication
(10) Pub. No.: US 2012/0078800 A1
(43) Pub. Date: Mar. 29, 2012

(54) METHOD FOR SECURE TRANSACTIONS

(75) Inventors: Stefan Hultberg, Stockholm (SE); Magnua Westling, Stockholm (SE)

(73) Assignee: ACCUMLATE AB, Stockholm (SE)

(21) Appl. No.: 13/321,779

(22) PCT Filed: Jun. 4, 2010
(86) PCT No.: PCT/SE2010/050615

§ 371 Date: Dec. 8, 2011

(30) Foreign Application Priority Data
Jun. 4, 2009 (SE) 0950409-3

(51) Int. Cl. G06Q 20/40

(52) U.S. Cl. 705/75

(57) ABSTRACT

The present invention relates to a method for a secure transaction wherein a buying part of the secure transaction utilizes a portable radio communication device (10) and RFID means (16), wherein both the buying part (10) and the selling part (11) in the secure transaction are protected against fraudulent actions, among other things by use of a common transaction identity on a predefined transaction server (12).

### FIELD OF INVENTION

The present invention relates generally to transactions, and particularly to secure transactions utilizing a portable radio communication device, such as a mobile phone, personal digital assistant, portable computer or similar device.

### BACKGROUND

It is today common with transactions initiated and performed via e.g. Internet. Further, with mobile phones or similar devices it is today possible to perform transactions and related actions through data communication via wireless communication. This provides for a very neat way of performing secure transactions, by always having an electronic authentication device at hand, which could be used as a secure wallet/bank solution. However, this also provides for a variety of ways to manipulate the transaction systems in order to fraud one or both of the parts in a transaction.

### SUMMARY OF THE INVENTION

An object of the present invention is thus to provide secure transactions for portable radio communication devices.

This object, among others, is according to the present invention attained by a method as defined by the appended claims.

By providing a method for a secure transaction, wherein a buying part of the secure transaction utilizes a portable radio communication device and RFID means, comprising the steps of: initiating, by wireless encrypted communication, the portable radio communication device on a predefined transaction server, which portable radio communication device thereby is put in an active transaction state as the buying part on the transaction server, a user transaction software in the portable radio communication device has been installed through an authenticated service provider, wherein the RFID means is identified and tied to the installation; initiating, by a predefined transaction identity known by the transaction server and the buying part, a secure transaction between the buying part utilizing the RFID means as the predefined transaction identity and a selling part utilizing a service provider software; initiating the selling part on the predefined transaction server, which selling part thereby is put in an active transaction state on the transaction server; sending information of the secure transaction connected to the predefined transaction identity from the selling part to the predefined transaction server; identifying the buying part and the selling part on the transaction server by the predefined transaction identity and checking that the buying part and the selling part are in the active transaction state on the transaction server; and finalizing the transaction connected to the predefined transaction identity based on the information of the secure transaction and the predefined transaction identity, a secure transaction is achieved at the same time providing an simple way of performing the transaction.

For improved security the secure transaction preferably comprises the steps of: sending, by wireless communication, the information of the secure transaction connected to the predefined transaction identity from the predefined transaction server to the buying part, wherein the transmission is encrypted; verifying the transaction connected to the predefined transaction identity at the buying part by a user verification; and sending, by wireless communication, the verification connected to the predefined transaction identity from the buying part to the transaction server, wherein the transmission is encrypted.

The verification is preferably performed by entering a personal identification number (PIN) in the portable radio communication device, which PIN is selected during installation of the user transaction software.

Advantageously, a portable radio communication device having built-in RFID means is preferably utilized for the secure transaction. Alternatively, the RFID means is provided separated from the portable radio communication device, e.g. as a sticker attachable to the portable radio communication device or a wallet of the user.

The secure transaction is preferably initiated by utilization of an RFID reader at the selling part, whereby the transaction is easy to perform.

In order for the user to not forget the portable radio communication device in the active state on the predefined transaction server, the buying part is preferably put in a non-active state on the predefined transaction server after a time-out.

For a more secure handling of the active state on the predefined transaction server the buying part is preferably put in a non-active state on the predefined transaction server after finalization of a secure transaction.

During manufacturing of an RFID means the predefined transaction identity is preferably added thereto, in order to securely tie the predefined transaction identity to the RFID means.

Further features and advantages of the present invention will be evident from the following description.

### BRIEF DESCRIPTION OF THE DRAWINGS

The present invention will become more fully understood from the detailed description of embodiments given below and the accompanying figures, which are given by way of illustration only, and thus, are not limitative of the present invention, wherein:

FIG. 1 schematically shows communication between transaction parts according to an embodiment of the present invention.

FIG. 2 schematically shows the steps of a method for secure transactions according to an embodiment of the present invention.

### DETAILED DESCRIPTION OF EMBODIMENTS

In the following description, for purpose of explanation and not limitation, specific details are set forth, such as particular techniques and applications in order to provide a thorough understanding of the present invention. However, it will be apparent for a person skilled in the art that the present invention may be practiced in other embodiments that depart from these specific details. In other instances, detailed description of well-known methods and apparatuses are omitted so as not to obscure the description of the present invention with unnecessary details.

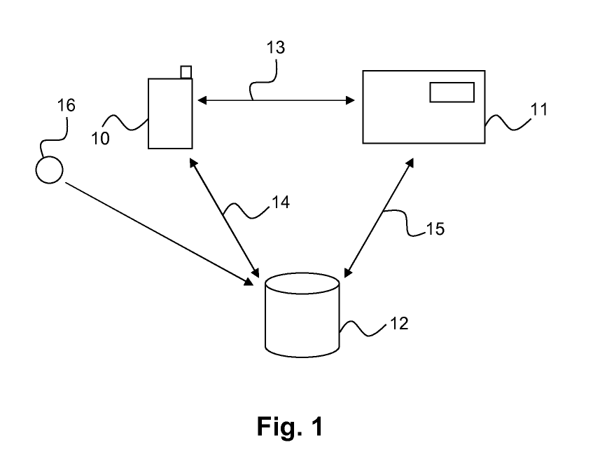

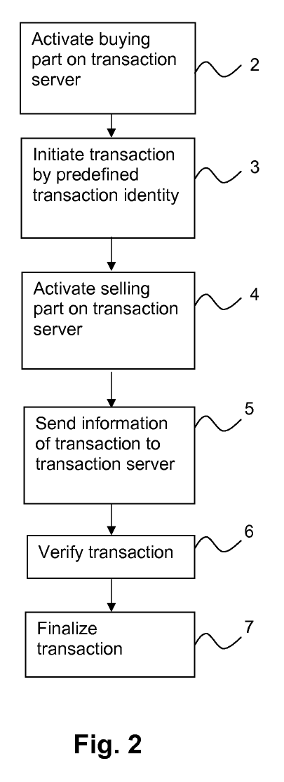

A method for secure transactions according to an embodiment of the present invention will now be described with reference to FIGS. 1 and 2.

The transaction parts participating in a secure transaction according to this embodiment of the present invention is a buying part 10, a selling part 11, a predefined transaction server 12, and RFID means 16.

The method for a secure transaction, wherein the buying part utilizes a portable radio communication device 10 and RFID means 16, starts by initiating, by wireless encrypted communication, the portable radio communication device 10 on the predefined transaction server 12, which portable radio communication device 10 thereby is put in an active transaction state as the buying part 10 on the transaction server 12. A user transaction software in the portable radio communication device 10 has been installed through an authenticated service provider, wherein the RFID means is identified and tied to the installation and the active transaction state on the predefined transaction server.

The secure transaction is initiated between the buying part 10, utilizing the RFID means 16 as a predefined transaction identity, and a selling part 11, utilizing a service provider software, wherein the predefined transaction identity is known by the transaction server and stored in the RFID means. Preferably, the predefined transaction identity stored on the RFID means is encrypted, and only a selling part having the right key can read the predefined transaction identity stored thereon. Alternatively, a selling part could request the right key from the predefined transaction server. Further, a selling part could utilize the encrypted predefined transaction identity when communication with the predefined transaction server, and only the transaction server has access to the right key.

The selling part 11 thereafter initiate itself on the predefined transaction server 12, which selling part 11 thereby is put in an active transaction state on the transaction server 12. The selling part 11 is also considered in an active transaction state on the transaction server 12, even if the communication between the selling part and the transaction server is indirect. Intermediate acquirers and issuers between the selling part and the transaction server in a distributed multi-nod system authenticating the selling part on the transaction server do not change the fact that the selling part is considered to be in an active state on the transaction server.

Information of the secure transaction connected to the predefined transaction identity is thereafter sent from the selling part 11 to the predefined transaction server 12. The initiating of the selling part on the transaction server and the following information of the transaction could also be performed in one action, such that the sending of information of the transaction to the transaction server also puts the selling part in an active transaction state on the transaction server.

The buying part 10 and the selling part 11 is identified on the transaction server 12 by the predefined transaction identity and it is checked that both the buying part 10 and the selling part 11 are in the active transaction state on the transaction server 12.

The secure transaction preferably also comprises verification of the transaction by the buying part. An advantage with such a verification is that the buying part sees what the transaction information comprises before the transaction is finalized, whereas a drawback with such a verification is that for simple and reliable purchases, such as purchase of buss tickets, the transaction process is unnecessary complicated. The buying part can preferably set a parameter on the transaction server to indicate if a verification of a transaction should be utilized or not for the buying part. The parameter could instead of being a simple yes or no flag, be transaction amount related, such that e.g. transaction amounts below SEK 100 requires no verification but transaction amounts there above requires a verification of the buying part.

For verification of the secure transaction the information of the secure transaction connected to the predefined transaction identity is sent, by wireless communication, from the predefined transaction server to the buying part, wherein the transmission is encrypted. The transaction connected to the predefined transaction identity is verified at the buying part by a user verification, preferably performed by entering a personal identification number (PIN) in the portable radio communication device, which PIN is selected during installation of user transaction software.

Thereafter the verification connected to the predefined transaction identity is sent, by wireless communication, from the buying part to the transaction server, wherein the transmission is encrypted.

The transaction connected to the predefined transaction identity is finalized based on the information of the secure transaction and the predefined transaction identity, and a secure transaction is achieved at the same time providing an easy way of performing the transaction. After finalizing the transaction a transaction receipt is preferably sent to both the buying part, through an encoded/encrypted wireless communication, and the selling part. The transaction is only finalized provided that the accounts of both the buying part and the selling part accept the transaction.

A user transaction software is installed in the portable radio communication device 10 of the buying part in a secure way, wherein a user is identified in a secure way and tied to the installation. One secure way is to, at e.g. a bank office or other known part, install the user transaction software in the portable radio communication device of the buying part or give a memory card or similar device having an installation program for the first transaction part thereon. The identity of the owner of the portable radio communication device is checked in connection with the installation or delivery of the user transaction software transaction program. Instead of checking the identity directly at a bank office or other known part e.g. a registered letter sent to the intended user can be used to verify the identity of the intended user. Finally the user transaction software is connected to an account at the bank or other part, such as a credit card account, a user account, an electronic wallet, etc. Another secure way to install the user transaction software is to, at e.g. an authenticated Internet bank office or similar part, through a secure connection, e.g. a https connection, install the user transaction software in the portable radio communication device of the first transaction part. The identity of the owner of the portable radio communication device is checked in connection with the installation through e.g. PIN. Finally the user transaction software is connected to an account at the bank or other part, such as a credit card account, a user account, an electronic wallet, etc.

The user transaction software is arranged to communicate with a predefined transaction server 12 when secure transactions are performed. Information of which account a user transaction software is connected to can be predefined directly at the transaction server or be accessed by the transaction server from the buying part whenever a transaction is to take place. Account balance and similar checks are preferably performed prior to any finalization of a transaction.

When a secure Internet installation is utilized a mobile phone number is preferably given to the distribution site, which in response thereto sends a text message, such as an SMS, with a download URL to that mobile phone number, i.e. a so called over the air installation (OTA installation). By following that link in the mobile phone the user transaction software is installed in the mobile phone. To first start the application run by the user transaction software an activation code, given by the distribution site, is entered. Further, a PIN is also required to be entered to run the application.

The user of the portable radio communication device, i.e. the buying part, selects a “RFID” section of the user transaction software to connect the buying part to the transaction server and put the RFID means in an active transaction state thereon.

The buying part 10 preferably stays in the active transaction state on the transaction server 12 until the buying part 10 requests a non-active transaction state. Alternatively, the buying part 10 will be put into a non-active transaction state by the transaction server 12 after a time-out. Further, the transaction server 12 could also put the buying part 10 in a non-active state after finalization of a transaction. By waiting for a request before putting the buying part into a non-active state the advantage is obtained that the user can perform several consecutive transactions without having to reselect the “RFID” section of the user transaction software. This is however preferably combined with a time out, which gives the advantage that the user does not risk forgetting to put the portable radio communication device in a non-active transaction state on the transaction server, which would be risky if another person gets hold of the portable radio communication device. From a security perspective it would be advantageous to put the buying part in a non-active transaction state also after a transaction have been completed.

A portable radio communication device having built-in RFID means is preferably utilized for the secure transaction. Alternatively, particularly usable in connection with a portable radio communication device not supporting RFID, the RFID means is provided separated from the portable radio communication device, e.g. as a sticker attached to the portable radio communication device or to a wallet of the user, or a marker/label arranged in a wallet or even operated into a user.

The secure transaction is preferably initiated by utilization of an RFID reader at the selling part, whereby the transaction is very simple to perform. As long as the portable radio communication device is in the active transaction state on the predefined transaction server the buying part can purchase e.g. a buss ticket by simply have an RFID reader read the RFID means.

During manufacturing of an RFID means the predefined transaction identity is preferably added thereto, in order to securely tie the predefined transaction identity to the RFID means. Otherwise the predefined transaction identity is e.g. written to the RFID means in connection with the secure installation of the user transaction software on the portable radio communication device.

The wireless communication can e.g. be performed through GPRS, 3G data, Wi-Fi or WiMAC, all of which could have some kind of built-in identity verification, and even infrared or Bluetooth, which however are anonymous and could require some added identity verification.

Transaction information from the second transaction part that is sent with a transaction can vary, but typically includes the name of the selling part and the transaction amount, and possibly also the product name, at a purchase. The name of the selling part could alternatively be extracted from the login of the selling part to the system instead of being sent together with the transaction, to ensure that such information is not distorted. This is usually performed via a landline, but could also be performed via wireless communication. The selling part has previously registered an account at the transaction server, in a way similarly performed for the buying part. Account information or similar information of the buying part is not necessary to give to the selling part and vice versa, since such information is known by the transaction server, and such information should thus not be given to the selling part and vice versa.

The user transaction software requests 6 e.g. a PIN as verification of the transaction information, such as name of the second transaction part and transaction amount.

It will be obvious that the present invention may be varied in a plurality of ways. Such variations are not to be regarded as departure from the scope of the present invention as defined by the appended claims. All such variations as would be obvious for a person skilled in the art are intended to be included within the scope of the present invention as defined by the appended claims.

1-11. (canceled)

12. A method for a secure transaction, wherein a buying part of said secure transaction utilizes a portable radio communication device and RFID means, comprising the steps of:
initiating, by wireless encrypted communication, said portable radio communication device on a predefined transaction server, which portable, radio communication device thereby is put in an active transaction state as said buying part on said transaction server, a user transaction software in said portable radio communication device has been installed through an authenticated service provider, wherein said RFID means is identified and tied to the installation;
initiating, by a predefined transaction identity known by said transaction server and said RFID means, a secure transaction, between said buying part utilizing said RFID means as said predefined transaction identity and a selling part utilizing a service provider software;
initiating said selling part on said predefined transaction server, which selling part thereby is put in an active transaction state on said transaction server;
sending information of said secure transaction connected to said predefined transaction identity from said selling part to said predefined transaction server;
identifying said buying part and said selling part on said transaction server by said predefined transaction identity; and finalizing said transaction connected to said predefined transaction identity based on said information of said secure transaction and said predefined transaction identity.

13. The method as claimed in claim 12, comprising the step of:
checking that said buying part and said selling part are in said active transaction state on said transaction server.

14. The method as claimed in claim 12, comprising the steps of:
sending, by wireless communication, said information of said secure transaction connected to said predefined transaction identity from said predefined transaction server to said buying part, wherein the transmission is encrypted;
verifying said transaction connected to said predefined transaction identity at said buying part by a user verification; and
sending, by wireless communication, the verification connected to said predefined transaction identity from said buying part to said transaction server, wherein the transmission is encrypted.

15. The method according to claim 14, wherein said verification is performed by entering a personal identification number in said portable radio communication device.

16. The method as claimed in claim 12, wherein said RFID means is provided within said portable radio communication device.

17. The method as claimed in claim 12, wherein said RFID means is provided separated from said portable radio communication device.

18. The method as claimed in claim 12, wherein said secure transaction is initiated by utilization of an RFID, reader at said selling part.

19. The method as claimed in claim 12, wherein said buying part is put in a non-active state on said predefined transaction server after a predetermined period of time.

20. The method as claimed in claim 12, wherein said buying part is put in a non-active state on said predefined transaction server after finalization of said secure transaction.

21. The method as claimed in claim 12, wherein said predefined transaction identity is added to said RFID means during manufacturing thereof.

22. The method as claimed in claim 12, wherein said predefined transaction identity is encrypted on said RFID means.
